(19) United States
(12) Patent Application Publication
(10) Pub. No.: US 2008/0247518 A1
(43) Pub. Date: Oct. 9, 2008

(54) WEB COMMUNICATING DEVICE FUNCTIONED AS BRIEFING CONTROLLER

(76) Inventor: Kwan Ho, Sindian City (TW)

Correspondence Address: HDSL, 4331 STEVENS BATTLE LANE, FAIRFAX, VA, 22033, US

(21) Appl. No.: 11/755,841

(22) Filed: May 31, 2007

(30) Foreign Application Priority Data
Apr. 4, 2007 (TW) 096205516

(51) Int. Cl. H04M 1/64

(52) U.S. Cl. 379/88.04

(57) ABSTRACT

The invention discloses a web communicating device, within which a web communicating function and a briefing controller function are coexisted, and a central processing unit is provided for processing the voice signal of a web communication and the control signal of a briefing controller is a way, such that a priority choice may be made for handling either mode in time; according to the invention, an online communication may be made by dialing a keypad to receive an agreement of the counter part, and the message may be further displayed on a display by changing the voice frequency through a voice control module; under a briefing mode, the briefing page may be controlled by the keypad, one key of which can make a lighting module emit visible light, in the meantime, the coming communication being hold or rejected through a preset function.

### BACKGROUND OF THE INVENTION

1. Field of the Invention

The present invention generally relates to a handheld device, in particular, to a web communicating device capable of switching between a briefing controller mode and a web communicating mode.

2. Description of Prior Art

A VoIP (Voice over IP), also called a web telephone, which is a technique that applies Internet to transmit voice package by a digitalizing manner, is arisen quickly and spread widely among users in recent years, because of the cheap communication fee following the maturating trend of broadband network and the gradually promoting advantage of telecommunicating policy. Compared to the traditional telephone functioned by an analogous transmission, Internet telephone may set up a special communicating passage between two parties via PSTN (public switched telephone network).

Common Internet telephone only possesses a communication function without any other additionally added value, except of auxiliary functions designed with respect to main body, such as, blinking or vibration for reminding user a coming call.

On the other hand, according to the prior arts, a wireless briefer, commonly seen in the market, just like most wireless auxiliary, is operated under two techniques, namely, the Bluetooth and Radio Frequency (RF). The operation distance of the Bluetooth is farther than that of the Radio Frequency, but both techniques do have the same problem: the operation is easily interfered, and the most interference comes from the outsides, not from the device itself. For example, the wireless briefer is often interfered by the frequency of same bandwidth used by other wireless products, for example, wireless network, wireless phone, and wireless video/audio transmission system, which are wireless devices gradually prevalent in recent years, such that the phenomenon of this signal interference becomes more and more serious, making it frequently difficult to receive the emitted signals.

Accordingly, through continuous study and improvement, the applicant combines the features of aforementioned two products to finally develop an innovative invention that solves the application aspect of web telephone and the operational inconvenience of wireless briefer, which is caused by outside interference.

### SUMMARY OF THE INVENTION

Regarding aforementioned objectives, the present invention is to attach the operational function of a briefer onto a web-communicating device. In other words, a web telephone of simple communication device can be improved to have the function of a briefer, and thus the objective of adding value is fulfilled.

Another objective of the present invention is to provide a central processing unit, which may handle the voice signal of a web communication and the control signal of a brief controller, and thus a priority choice may be made in time according to a predefined processing procedure.

In order to avoid electromagnetic interference, the present invention is connected to a computer mainframe via a cable, such that it may indeed keep the briefing operation from interference, but also the voice quality of the web telephone may be kept as real as possible.

The technical mechanisms according to the present invention in solving the aforementioned problems are described thereinafter.

The invention proposes a web communicating device capable of being served as a briefing controller, the interior of the device consisting a central processing unit electrically connected to a key module, a voice control module, a power control module, and a lighting module; wherein the central processing unit may process the voice signal of a voice communication and the control signal of a briefing controller, and may make a management of priority choice in time according to a predefined processing mode; a display module is capable of displaying message status; the key module has the functions of dialing number for communication and briefing control, and is operatively matched with a keypad; the voice control module may make interchanges between analogous voice frequency signals and digital signals; the power control module may receive power through transmission line, and may make the central processing unit operative.

Under a briefing mode, the keypad matched with the key module has a key that is actuated by power control module to make the lighting module emit visible light, which is commonly emitted from a laser diode for an indicating purpose during a briefing. The keypad, matched with aforementioned key module, at least includes a set of numeral keys for dialing number and a set of briefing keys for sending paging signals to a computer to effect a briefing's page change.

Compared to the prior arts, the invention has the advantage for integrating the techniques and the structures of two electronic devices; namely, a single handheld device simultaneously possesses the functions of a web telephone and a briefer, solving the drawback of the web telephone only having telecommunicating function without any other added value. Regarding the part of signal transmission, since of a cable connected between the computer and the handheld device, the interference of signal transmission may be avoided.

### BRIEF DESCRIPTION OF DRAWING

The features of the invention believed to be novel are set forth with particularity in the appended claims. The invention itself, however, may be best understood by reference to the following detailed description of the invention, which describes several exemplary embodiments of the invention, taken in conjunction with the accompanying drawings, in which:

FIG. 1 is an appearance view of the device according to the present invention;

FIG. 2 is a module block diagram according to the present invention;

FIG. 3 is a flowchart of the computer side under a briefing mode;

FIG. 4 is a flowchart of the invention under a briefing mode; and

FIG. 5 is a connection illustration of an application embodiment according to the present invention.

### DETAILED DESCRIPTION OF THE INVENTION

In cooperation with attached drawings, the technical contents and detailed description of the present invention are described thereinafter according to a number of preferable embodiments, being not used to limit its executing scope. Any equivalent variation and modification made according to appended claims is all covered by the claims claimed by the present invention.

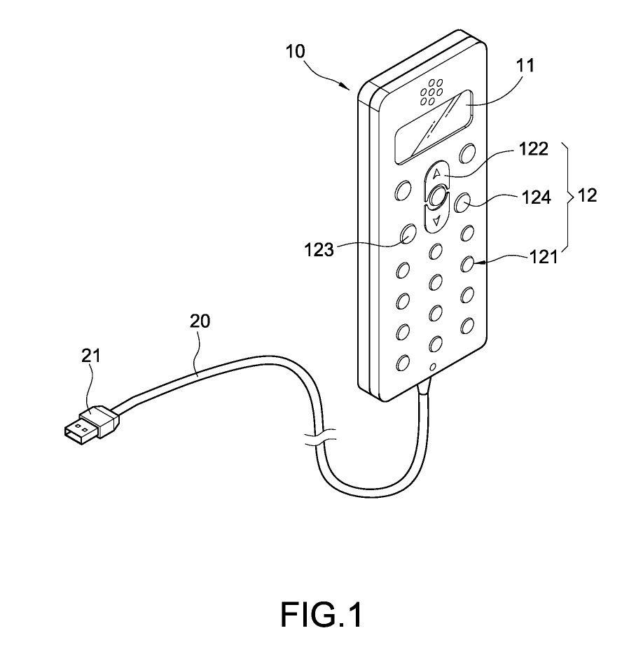

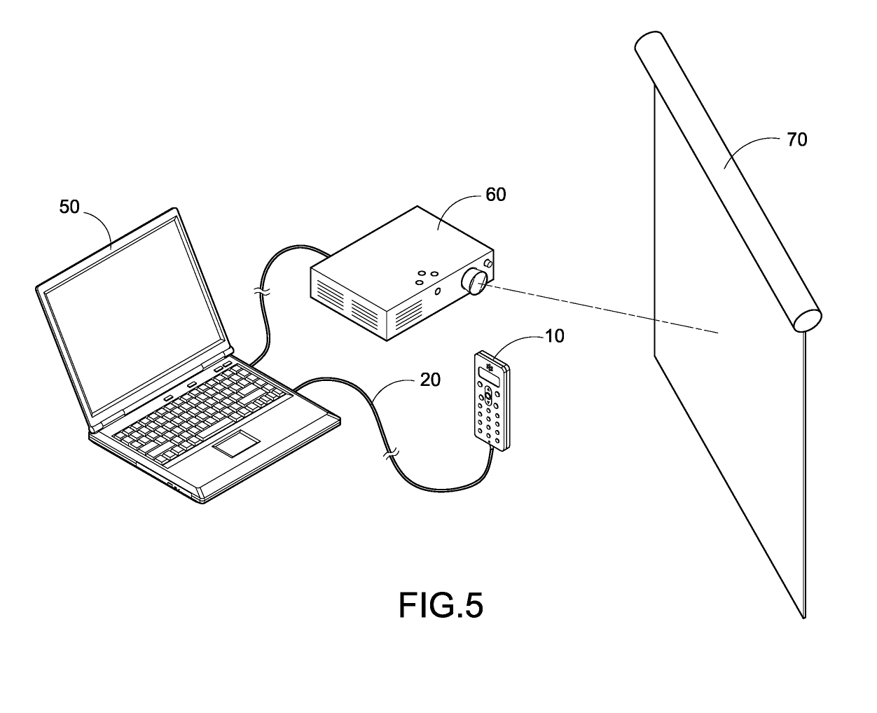

Please refer to FIG. 1, which is an appearance view of a preferable embodiment according to the present invention, wherein the device has a main body 10 connected by a connecting line 20 having a USB plug 21 to be plugged into a connector of a computer mainframe (as shown in FIG. 5) at remote end of the main body 10. The USB plug 21 has a specification of high transmission rate, and may provide a sufficient power, needed by the device according to the present invention, from the computer mainframe. A USB plug is taken as an example, being not a limitation to the scope of the invention though.

A display 11, disposed at upper portion of the main body 10, may display the working messages of the communicating objects, the working status, and the prompting messages, etc., for example. In addition, a keypad 12, disposed below the display 11 of the main body 10, includes a set of numeral keys 121 matched with the web phone for dialing numbers, and a set of briefing keys 122 matched with a briefer function. Numbers may be dialed out to look for an object to be online through the numeral key set 121, and the briefing key set 122 may be functioned to make the computer generate signal of page change, which will in turn make the briefing contents generate page changing motion, while other keys of basic functions, for example, the communicating key 123 and the ending key 123, won't be described in detailed herein.

Furthermore, the device of the invention may apply any key in the keypad 12 disposed on the main body 10 as an actuating key to actuate a briefing mode. Except of the front face of the main body 10, on which the aforementioned keys may be arranged, they also may be arranged on the side faces of the main body 10.

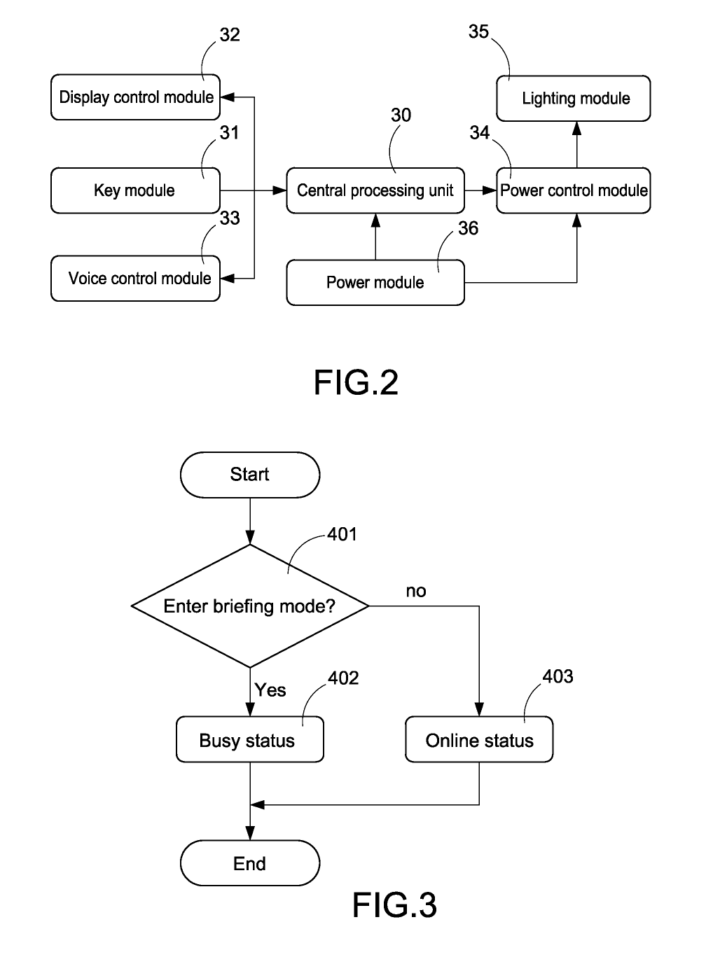

Please refer to FIG. 2, showing a module block diagram of a preferable embodiment according to the present invention. The interior of the device includes a central processing unit 30 that is a microprocessor and is electrically connected to a key module 31, a display control module 32, a voice control module 33, a power control module 34, and a lighting module 35.

The device according to the present invention simultaneously provides a communicating function and a briefing function, wherein the central processing unit 30 may process the voice signal of a web communication and the input control signal of a briefing controller, and may make a priority choice in time according to a predefined process mode; the display control module 32 may then control the message status displayed in the display, which is a message needed by the user when the device is operative; the key module 31 is controlled by the keypad 12, by which the communicating numbers are dialed and the signal generating side with briefing function is controlled, such that the signals to be processed may be electrically sent to the central processing unit 30; in addition, under the briefing mode, one key of the keypad 12 is applied, actuating the lighting module 35 to emit visible light, which is usually emitted from a laser diode for indicating the briefing contents; the voice control module 33 may make an interchange between the analogous voice frequency signal and the digital signal, while the central processing unit 30 may send the changed voice signal to a computer mainframe 50 (as shown in FIG. 5), where a bidirectional transmission may be made through Internet.

In addition, the invention further includes a power module 36, which is electrically connected to the central processing unit 30 and the power control module 34, providing the power needed by the central processing unit 30 and the lighting module 35, and making the central processing unit 30 operative.

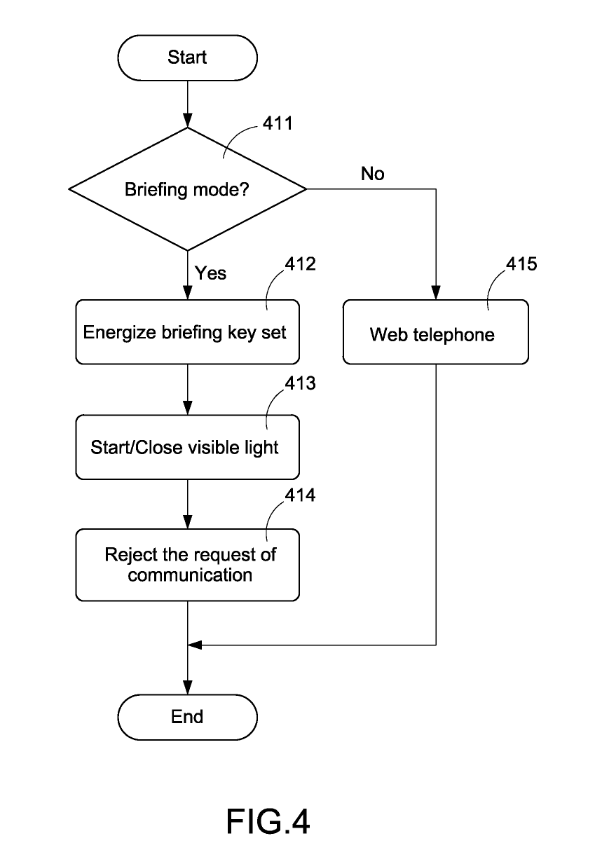

As shown in FIG. 3 and FIG. 4, the central processing unit 30 of the invention is characterized in a briefing mode, the purpose of which may make a priority briefing management. When entering a briefing mode, the computer side will receive the message sent from the central processing unit 30, making the computer communicating interface display a busy status 402. During usual time, the invention will be used as a web phone, and the computer communicating interface will display an online status. The main objective of this arrangement is to avoid an abrupt power interrupt during a briefing procedure, in particular, during a normal briefing, but this situation can be avoided, because of this setup.

Within the device according to the present invention, the central processing unit 30 may receive a preset signal, making the device enter a briefing mode, wherein a preset signal may be effected by a key of the keypad 12 by means of the actuation of the key module 31, before that the device is under a web phone function; after entering the briefing mode, the keypad is energized 412, and is capable of transmitting an order signal, making the briefing contents in the computer process a page changing management, via the briefing key set 122. One key of the keypad 12 is executed, such that the key may control the actuation of the power control module 34 to make the lighting module 35 starting or closing an emission of visible light 413, which is usually emitted from a laser diode, for the purpose of indicating the briefing contents.

Under this briefing mode, any request from the Internet communicating call will be rejected 414. However, under this situation, there may be some important messages that can not be missed so, through another way, a call prompt is included under a briefing mode; when a call is coming initially, the user will be reminded to receive the call or not to through viewing the message from the display 11.

Please refer to FIG. 5, showing a connecting illustration for an applying embodiment according to the present invention. Under a briefing mode, the main body 10 is connected to a personal computer 50 via a connecting cable 20. On the other hand, the computer 50 is further connected to a projector 60. In the meantime, the briefing key set 122 may be actuated to make the computer 50 generate a page changing signal, so that the briefing contents projected on the screen 70 by the projector 60 may be executed a page changing action. In addition, the device according to the present invention is capable of emitting a laser light for briefing indication, thereby, the briefing device becoming an added function for a web communicating device.

In summarizing aforementioned description, it should be noted that the web communicating device according to the present invention served as a briefing controller already has the applicability, the novelty, and the progressiveness for the industry, furthermore, the structure of the invention having never been seen in similar products or in public occasion, which is completely fulfilled the applying merit of a novel pattern, so the application is proposed according to the patent law.

What is claimed is:

1. A web communicating device capable of being served as a briefing controller, the interior of which includes a central processing unit that is electrically connected to a key module, a display control module, and a voice control module, wherein:
the central processing unit is capable of handling the voice signal of a web communication and the input control signal source of a briefing controller;
the key module is served as a signal generating side for dialing communicating numbers and for controlling the briefing functions, and sends the signal to the central processing unit;
the display module controls the display message status, which makes user obtain a desired message during the operation of the device; and
the voice module makes an interchange between an analogous voice frequency signal and a digital signal, and the changed voice signal is processed by the central processing unit.

2. The device according to claim 1, further including a power control module and a lighting module driven by the power control module, wherein the key module controls the actuation of the power control module, making the light module emit a visible light.

3. The device according to claim 2, wherein the visible light is emitted from a laser diode, for the indication of the briefing contents.

4. The device according to claim 2, further including a power module which is electrically connected to the central processing unit and the power control module, for providing the power needed by the central processing unit and the lighting module.

5. The device according to claim 1, wherein the key module has a starting key for starting a briefing mode.

6. A web communicating device, capable of being served as a briefing controller, and plugged connectedly to a computer mainframe, comprising:
a main body, having a connecting cable connected to the computer mainframe;
a central processing unit, arranged in the main body, and capable of handling the voice signal of a web communication and the input control signal source of a briefing controller;
a display, arranged on the main body, electrically connected to a display control module of the central processing unit, and controlled thereby to display signal status;
a keypad, also arranged on the main body, capable of controlling a key module electrically connected to the central processing unit, and served as a signal generating side for dialing communicating numbers and for controlling the briefing functions; and
a voice control module, arranged in the main body, electrically connected to the central processing unit, and capable of making an interchange between an analogous voice frequency signal and a digital signal.

7. The device according to claim 6, wherein the keypad includes a set of numeral keys capable of dialing numbers and a set of briefing keys matched with the briefer function and, numbers are dialed to look for a communicating object to be online through the numeral key set and, the computer generates page changing order to make the briefing contents generate page changing action through the briefing key set.

8. The device according to claim 6, wherein one side of the connecting cable, at remote side of the main body, has a USB plug.

9. The device according to claim 6, wherein one key of the keypad is served as a starting key for starting a briefing mode.
